(19) United States
(12) Patent Application Publication
(10) Pub. No.: US 2026/0125306 A1
(43) Pub. Date: May 7, 2026

(54) METHOD FOR SEPARATING A GLASS ELEMENT FROM A GLASS STRAND, GLASS ELEMENT AND BUNDLE OF GLASS ELEMENTS

(71) Applicant: Schott AG, Mainz (DE)

(72) Inventors: Christoph Bäumler, Mitterteich (DE); Reiner Artmann, Mitterteich (DE); André Witzmann, Waldershof (DE); Ulla Trinks, Mitterteich (DE); Volker Trinks, Mitterteich (DE); Stephan Tratzky, Mitterteich (DE)

(73) Assignee: Schott AG, Mainz (DE)

(21) Appl. No.: 18/845,670

(22) PCT Filed: Mar. 7, 2023
(86) PCT No.: PCT/EP2023/055690

§ 371 Date: Sep. 10, 2024

(30) Foreign Application Priority Data
Mar. 10, 2022 (EP) 22161370.6

(51) Int. Cl. C03B 33/06; C03C 23/00

(52) U.S. Cl. CPC C03B 33/06; C03C 23/0075

(57) ABSTRACT

The present invention relates to a method for separating a glass element from a glass strand. The invention further relates to a glass element and to a bundle.

### CROSS-REFERENCE TO RELATED APPLICATIONS

This application is a national stage entry under 35 U.S.C. § 371 of International Patent Application No. PCT/EP2023/055690 entitled “METHOD FOR SEPARATING A GLASS ELEMENT FROM A GLASS STRAND, GLASS ELEMENT AND BUNDLE OF GLASS ELEMENTS,” filed on Mar. 7, 2023, which is incorporated in its entirety herein by reference. International Patent Application No. PCT/EP2023/055690 claims priority to European Patent Application No. 22161370.6 filed on Mar. 10, 2022, which is incorporated in its entirety herein by reference.

### BACKGROUND OF THE INVENTION

### 1. Technical Field of the Invention

The present invention relates to a method for separating a glass element from a glass strand. The invention further relates to a glass element and to a bundle.

### 2. Description of the Related Art

In the state of the art, glass elements such as glass tubes might be subject to the contamination. Especially particles might accumulate on the surface, especially the inner surface, of the glass element.

The particles might originate for example from the manufacturing process of the respective glass element. In case of glass tubes one particularly severe source of particles is the process of confectioning the glass tubes from a glass tube strand. Here, the glass tubes might be lengthen from the glass tube strand by sawing or otherwise cutting. This comes along with the creation of a considerable amount of particles which predominantly accumulate in the region of the end sections of the glass tubes. After confectioning, the glass tubes, especially their end sections, are subsequently heated again in order to seal and shape the cutting edge.

However, this might lead to the situation that the loose particles in the end regions are connected with the surface of the glass tube in a firm manner. Of course, also particles originating from other sources such as dust, educts or dirt from the environment might then be attached to the glass element during heating likewise. Such particles often cannot be removed in a subsequent cleaning procedure so that they are still present in the final glass element.

Dependent on the purpose of the respective glass element, however, particles are highly undesired. For example if the glass element is intended to be used as pharmaceutical container for holding pharmaceutical compositions, a glass element of high quality, i.e. having no or almost no particles, is of particular importance. Especially particles attached to the inner surface of the glass element, such as the surface of a glass tube facing towards the lumen, are of high severity. If they get in contact with the pharmaceutical composition, the pharmaceutical composition might be contaminated either in that substances from the particles leak into the pharmaceutical composition or even that the particles as whole detach from the surface of the glass element and into the composition.

In conventional manufacturing processes of for example glass tubes, thus, after lengthening and prior to heating, pressurized air is used to remove particles from the inner surface of the glass tubes. This is accomplished in that a nozzle head injects an air stream into the glass tube from one end, in order to blow particles to the other end and, hence, out of the glass tube. While this procedure is easy to implement from a technical point of view, it suffers from disadvantages.

In this respect, only a portion of the air is actually injected into the glass tube, while the remainder is blown past the glass tube and might raise dust and the like in the environment. This in turn might lead to a new source of contamination. Furthermore, particles are blown from one end section to the other end section via the middle section, respectively, of the glass tube. Hence, there is the risk that this middle section afterwards is more contaminated as it initially has been the case. This is especially true since typically there are more particles in the end sections than in the middle section. It has also been noted that the high pressure leads to high noise emissions. In addition, since a laminar air flow is build up within the glass tube, the flow velocity at the inner surface of the glass tube decreases over the distance. Thus, the further the particles are located away from the end section, the lesser the interaction forces between the injected air flow and the particles becomes. Glass tubes exceeding a specific length, therefore, might not be cleaned along their entire length in a sufficient manner.

### SUMMARY OF THE INVENTION

It is, thus, an object of the present invention to overcome the disadvantages described above with respect to the state of the art by providing means which allow for a reduction of the contamination of glass elements with particles in an easy and cost-efficient manner. It is further the object of the present invention to provide a glass element of high quality and a bundle comprising such glass elements.

The problem is solved by the invention according to a first aspect in that a method for cleaning a glass element is proposed, the method comprising the steps of:
separating, at a separating location of a production site, a glass element from a glass strand;
moving the glass element from the separating location to a cleaning location at the same or another production site;
inserting, at the cleaning location, a nozzle head at a specific end of the glass element into the glass element and moving the nozzle head inside the glass element along a specific direction, which preferably is parallel to the center axis of the glass element, while the nozzle head does not release fluid; and
releasing fluid out of the nozzle head so as to flush particles attached at the inner surface of the glass element towards the specific end, especially as a first fluid releasing action, preferably while moving the nozzle head, especially within the glass element, along a direction which is opposite to the specific direction;
wherein at least during separating the glass element from the glass strand a suction of particles that preferably result from the separating is carried out.

The invention is, thus, based on the surprising finding that particles can be efficiently removed from a glass element if the nozzle head can be inserted into the glass element and removes particles by blowing them back to the closer end rather than via the middle section to the distant end, respectively, of the glass element.

This way particles can be efficiently removed from the glass element since they are blown from inside to outside. This can be realized in an efficient manner in that the nozzle head is inserted inside the glass element while the nozzle head does not release fluid and the nozzle head is moved within the glass element while releasing fluid from the nozzle head (during removal of the nozzle head).

When also a suction of particles that result from the separating process is carried out during separating the glass element from the glass strand, the total number of particles that can settle on the inner tube surface at all can be significantly reduced in a safe and reliable yet cost-efficient manner.

Furthermore, it has been realized by the inventors, that inserting the nozzle head into the glass element allows for an interaction between the fluid and the particles which is significantly increased. In addition, the particles are not blown across the middle section of the glass element. Hence, a more efficient cleaning process is possible.

Since the nozzle head can be inserted into the glass element, the fluid flow takes place effective only within the glass element. Furthermore, the entire fluid flow released by the nozzle head is directed towards the outside of the glass element. Thus, no particles from the outside can get into the glass element.

The inventive approach, thus, allows to adequately clean glass elements such as glass tubes of nearly arbitrarily length. Furthermore, it is sufficient and appropriate to insert the nozzle head only up to the center of the glass element or even less, for example particularly in the area where cleaning is required. Hence, the arm which holds the nozzle head can be designed shorter in length. This prevents an oscillation of the arm, hence the nozzle head. Thus, possible damages of the glass element due to collisions with the nozzle head are avoided.

It is possible that each of the two halves of the glass element can be cleaned independently from the respective two ends, especially in sequence and/or in parallel.

The center axis of the nozzle head is for example the rotation axis of the nozzle head.

The fluid preferably comprises a gas, in particular air, such as purified air, and/or nitrogen, and/or a liquid, in particular water, and/or a mixture of both, such as a mixture of air and a liquid.

Preferably the method comprises two or more than two fluid releasing actions which especially are carried out at least in part in parallel and/or at least in part in sequence. This allows to accomplish an improved cleaning process.

Preferably the nozzle head comprises a backward nozzle rim, which comprises a plurality of nozzle openings for releasing fluid, especially during the first fluid releasing action, and/or a forward-facing and/or centric nozzle opening pointing in the opposite direction for releasing fluid, especially during a second fluid releasing action (which is described in more detail below).

In one embodiment it might be preferred that the fluid is released out of the nozzle head, while moving the nozzle head within the glass element along the direction opposite to the specific direction until the nozzle head has left the glass element.

In one embodiment it might be preferred that the steps of inserting and releasing are performed in 1 minute or less, preferably 30 seconds or less, more preferably 15 seconds or less, more preferably 10 seconds or less, more preferably 5 seconds or less.

In one embodiment it might be preferred that the nozzle head comprises carbon fibers, a metal, a metal alloy or a polymer, more preferably the nozzle head comprises aluminum, steel, brass, polytetrafluorethylene or polyoxymethylene.

If for the nozzle head a plastic material is chosen, a quite robust nozzle head might be obtained. In addition the risk that the nozzle head damages the glass element during operation can be further reduced in that.

For example, the nozzle head can be fabricated using injection molding.

In one embodiment it might be preferred that the maximum outer diameter of the nozzle head is 50 mm or less, preferably of between 1 mm and 50 mm, more preferably of between 2 mm and 25 mm, most preferably of between 3 mm and 18 mm.

A preferred outer diameter allows to better clean glass elements.

In one embodiment it might be preferred that the inner diameter of the glass element is 3 mm or more, preferably 4 mm or more, more preferably 5 mm or more, more preferably 6 mm or more, more preferably 7 mm or more, more preferably 8 mm or more, more preferably 9 mm or more, more preferably 10 mm or more, more preferably 15 mm or more, more preferably 20 mm or more, and/or 20 cm or less, preferably 15 cm or less, more preferably 10 cm or less, more preferably 5 cm or less, more preferably 4 cm or less, more preferably 3 cm or less, more preferably 2 cm or less.

In one embodiment, the inner diameter of the glass element is larger than the maximum outer diameter of the nozzle head by at least 4 mm and at most 100 mm, or by at least 6 mm and at most 44 mm.

The smaller the distance between the nozzle head and the glass element, the more effective is the cleaning effect. However, the greater the distance between the nozzle head and the glass element, the faster the movement of the nozzle head can take place and the safer the cleaning process is with regard to not damaging the glass element. The preferred distances result in an advantageous cleaning effect while protecting the glass element from damage due to collision with the nozzle head.

For example, the maximum outer diameter of the nozzle head is 6 mm and the glass element has an inner diameter of between 12 mm to 100 mm, especially of 37 mm.

In one embodiment it might be preferred that the outer diameter of the glass strand and/or the glass element is between 6 mm and 60 mm, especially between 6 mm and 22 mm, between 8 mm and 22 mm, between 7 mm and 50 mm or between 9 mm and 25 mm.

In one embodiment it might be preferred that the inner diameter of the glass strand and/or the glass element is between 4 mm and 58 mm, especially between 4 mm and 19 mm, between 6 mm and 29 mm, between 5 mm and 47 mm or between 4 mm and 24 mm.

In one embodiment it might be preferred that separating the glass element from the glass strand comprises the following and/or the problem is solved by the invention according to a second aspect in that a method for separating a glass element from a glass strand, the method comprising separating, at a separating location of a production site, the glass element from the glass strand is proposed, wherein separating the glass element from the glass strand comprises the following:

causing at least one specific portion of the glass strand to vibrate, especially at least during separating the glass element from the glass strand.

It is highly appreciated that said features can be employed alone (e.g. as an individual stand-alone separating method or as a part thereof) and in any combination with features disclosed elsewhere in the present application (e.g. in combination with the cleaning method according to the first aspect of the invention).

It has surprisingly been found that by causing vibrations during the separation process, the quality of the cutting edge of the produced glass element can be significantly improved, in terms of a straight and particularly controllable course of the cutting edge.

It has been particularly recognized that even if the glass strand has variations of its parameters such as outer diameter, curvature and ovality, the introduced vibrations allow to produce uniform cutting edges across the successively separated glass elements.

In that the proposed vibrations are caused, uniform basic conditions are provided which can be easily controlled and which are the same for all glass elements to be produced. Hence, an improved and reproducible quality of the cutting edge be achieved.

Due to the controlled cutting edge, as a consequence, variation of the length of produced glass elements can be significantly reduced.

Furthermore, it has been found that fewer particles are generated during the cutting process if the glass strand is caused to vibrate during the separating process.

It is particularly surprising that although vibrations are introduced during the separating process, the contamination of the glass element with particles can be nevertheless reduced. This is due to the improved cutting edge and the associated reduced generation of particles. In addition, the vibration duration can be selected to be so short that any remaining particles do not reach or do substantially not reach into the interior of the glass element during vibration.

The separation process can, thus, be carried out in a more controlled manner, with more precision and with less creation of glass particles, hence, less contamination of the glass element.

Preferably the “causing to vibrate” takes place at least in part in parallel to another action directed to (especially physically) “separating” the glass element from the glass strand. In other words, it is preferred that the vibrations are not causally responsible for separating the glass element from the glass strand, but only influence and positively support the separating process. The vibrations alone (without an additional action of “separating”, which may take place in parallel to causing the vibrations in preferred embodiments) would therefore preferably not lead to a separation of the glass element. Whereas the separation process may preferably be carried out without introducing vibrations, albeit with preferably less good results.

Thus, preferably, the physical separation of the glass element from the glass strand is not achieved solely by causing the at least one specific portion of the glass strand to vibrate. One or more further actions have to be carried out, preferably in parallel to the action of causing the at least one specific portion of the glass strand to vibrate.

By using vibration technology in the glass strand separation process, mechanical influences can contribute to the tube geometry and thus a positive cutting edge can be caused by an intensive interaction of compressive and tensile stresses in the glass strand wall. This means that a “smooth” cutting edge can be produced and thus also fewer particles are created.

In particular, the at least one specific portion of the glass strand caused to vibrate can be a portion between a free end of the glass strand and a pulling device that pulls. i.e. moves, the glass strand. In other words, the vibration can be applied to the at least one specific portion of the glass strand between a free end of the glass strand and a pulling device that pulls. i.e. moves, the glass strand.

In one embodiment it might be preferred that the outer diameter of the glass strand and/or the glass element is between 6 mm and 60 mm, especially between 6 mm and 22 mm, between 8 mm and 22 mm, between 7 mm and 50 mm or between 9 mm and 25 mm.

In one embodiment it might be preferred that the inner diameter of the glass strand and/or the glass element is between 4 mm and 58 mm, especially between 4 mm and 19 mm, between 6 mm and 29 mm, between 5 mm and 47 mm or between 4 mm and 24 mm.

In one embodiment it might be preferred that separating the glass element from the glass strand comprises cutting the glass element from the glass strand at a cutting position on the glass strand and/or scribing the glass strand at a scribing position on the glass strand and scribe breaking the glass element from the glass strand at the scribing position

Preferably, the cutting position and/or the scribing position is within the specific portion of the glass strand.

In one embodiment it might be preferred that causing the glass strand to vibrate is suspended for a certain time between two successive separation processes, especially between two successive cutting and/or scribe breaking processes.

In one embodiment it might be preferred that the glass strand or at least portions thereof, such as the specific portion, is caused to vibrate during at least the separating process and/or for a duration of 1 ms or more, 10 s or less and/or between 1 ms and 10 s.

Optionally, the glass strand is caused to vibrate only during the separation process.

In one embodiment it might be preferred that the glass strand is caused to vibrate continuously.

In one embodiment it might be preferred that the glass element is separated from the glass strand within the specific portion of the glass strand which vibrates.

In one embodiment it might be preferred that the glass element is separated from the glass strand at a first position, especially a first horizontal position, which is displaced, especially by 10 mm or more and/or by 300 mm or less, from a second position, especially a second horizontal position, where the vibrations are transmitted to the glass strand, wherein the displacement is preferably a horizontal displacement.

This way the vibrations can be introduced in the glass strand at a distant location compared to the location where the cutting process is carried out at the glass strand.

In one embodiment it might be preferred that the vibrations being transmitted to the glass strand by at least one glass strand support, such as at least one roller or at least one prism, which carries the glass strand at least in areas.

For example, the glass strand support may be the last one of a series of successively arranged supports along a direction parallel to the main extension of the glass strand. However, only the last one (e.g. the one next to the place where the separation takes place) may be designed to transmit the vibrations while the others do not transmit vibrations to the glass strand.

For example, the roller, especially said last one, may comprise or may be made of carbon and/or coal. In one embodiment the roller comprises coal and carbon, wherein the two materials are layered together.

In one embodiment it might be preferred that the support carries out vibrations, especially along a direction perpendicular to the direction of main extension of the glass strand, which are transmitted to the glass strand, especially via direct contact between the support and the glass strand.

The respective glass strand support might comprise a vibration unit. This makes it possible causing at least one specific portion of the glass strand, especially an end section of the glass strand, to vibrate. For example, the vibration unit can be a turbine vibrator. In one embodiment the vibration unit is designed as the glass strand support. Alternatively or in addition, the vibration unit can be operatively coupled to the glass strand support so that the vibrations of the glass strand support are caused and/or controlled by the vibration unit.

This can be easily realized, e.g. by means of a piezo element provided within the support.

In one embodiment it might be preferred that the vibrations being transmitted to the glass strand by means of an ultrasonic transmitter, especially without contact, via molded carbon and/or via the air.

For example, the molded carbon may be in direct contact with the class strand (at least at a certain position) and/or with the ultrasonic transmitter.

In one embodiment it might be preferred that the frequency of the ultrasonic transmitter and/or of the vibrations carried out by the roller is 100 Hz or larger and/or 1 MHz or less.

For example, the frequency might be between 20000 Hz and 40000 Hz, such as between 20000 Hz and 30000 Hz or 30000 Hz and 40000 Hz.

In one embodiment it might be preferred that the frequency of the vibrations of the glass strand, especially in the specific portion, is 100 Hz or larger and/or 1 MHz or less.

In one embodiment it might be preferred that the frequency of the ultrasonic transmitter and/or of the vibrations carried out by the roller is between 20000 Hz and 40000 Hz, especially between 30000 Hz and 35000 Hz or between 31000 Hz and 33000 Hz, such as 32000 Hz.

For example, the vibrations may be generated by means of a turbine vibrator, which in turn may be coupled to the glass strand support so that the glass strand support vibrates accordingly. For example, the turbine vibrator can be arranged inside the glass strand support. Alternatively, the turbine vibrator can be formed as glass strand support or can be part of the glass strand support. This allows a compact design of the device.

In one embodiment it might be preferred that the suction of particles that result from the separating is carried out in that a negative pressure is generated, especially in at least one volume area outside of the glass element and/or adjacent to a cutting edge of the glass element formed by the separating.

Preferably the negative pressure means a pressure which is lower than the ambient pressure.

In one embodiment it might be preferred that particles produced during separating the glass element from the glass strand, and especially deposited on an inner surface of the glass element, are, preferably substantially, held in position relative to the glass element at least until the glass element arrives at the cleaning location.

As already outlined above, the particles originated from the separating process do not move due to preferably caused vibrations of the glass strand.

In one embodiment it might be preferred that moving the glass element from the separating location to the cleaning location comprises moving the glass element, preferably substantially, with a transport frequency (a) of 100 Hz or less, preferably of 70 Hz or less, preferably of 50 Hz or less, preferably of 30 Hz or less, preferably of 10 Hz or less, preferably of 5 Hz or less, (b) of 0.1 Hz or more, preferably of 1 Hz or more, preferably of 10 Hz or more, preferably of 50 Hz or more, and/or (c) of between 0.1 Hz and 100 Hz, preferably of between 1 Hz and 60 Hz.

In one embodiment it might be preferred that moving the glass element from the separating location to the cleaning location comprises moving the glass element (a) in a position where it has an extension along a horizontal axis in the world coordinate system, (b) without rotating it by more than ±20 degrees, preferably by more than ±15 degrees, preferably by more than ±10 degrees, preferably by more than ±5 degrees, preferably by more than ±1 degree, about at least one rotation axis, which preferably is perpendicular to the center axis of the glass element, has a horizontal extension in the world coordinate system and/or crosses the center of the glass element, and/or (c) without rotating it by more than ±20 degrees, preferably by more than ±15 degrees, preferably by more than ±10 degrees, preferably by more than ±5 degrees, preferably by more than ±1 degree, about at least one rotation axis, which preferably is parallel to or equal to the center axis of the glass element, has a horizontal extension in the world coordinate system and/or crosses the center of the glass element.

In one embodiment it might be preferred that the steps of inserting and releasing are performed in 1 minute or less, preferably 30 seconds or less, more preferably 15 seconds or less, more preferably 10 seconds or less, more preferably 5 seconds or less.

In one embodiment it might be preferred that the glass element has only one open end, especially along the center axis of the glass element and/or wherein the specific end is the only open end of the glass element.

In one embodiment it might be preferred that the nozzle head is moved inside the glass element to a minimal distance which is located more than 5 cm, preferably more than 10 cm, preferably more than 15 cm, preferably more than 20 cm, preferably more than 25 cm, away from the specific end and/or to a maximal distance which is located less than 100 cm, preferably less than 50 cm, preferably less than 40 cm, preferably less than 35 cm, preferably less than 30 cm, preferably less than 20 cm, away from the specific end.

In one embodiment it might be preferred that the inner surface of the glass strand, when pulled off a Danner pipe, is free of particles having a size of 50 μm or more.

In one embodiment it might be preferred that the method comprises releasing fluid out of the nozzle head along at least one direction pointing away from the specific end and/or along at least one direction parallel to the specific direction, especially as a second fluid releasing action, wherein (i) the second fluid releasing action is carried out at least intermittently (i.e. from time to time) while the first fluid releasing action is carried out, preferably throughout (i.e. all the time) while the first fluid releasing action is carried out, (ii) the second fluid releasing action is not carried out while the first fluid releasing action is not carried out, (iii) the second fluid releasing action is carried out at the same time when the first fluid releasing action is carried out and/or (iv) the fluid is released while, especially only while, moving the nozzle head, especially within the glass element, along the direction which is opposite to the specific direction.

It surprisingly turned out that releasing fluid in that way (especially in addition to releasing fluid so as to flush particles to the specific end) prevents particles being sucked from the other half of the glass element. The inventors have found that this might be due to a kind of pressure equalization which is achieved that way. Likewise, in case a glass element is cleaned from both ends by two respective nozzle heads in parallel, releasing fluid in said manner prevents the creation of a negative pressure within the glass element and the suction of particles.

Thus, no particles from outside can get into the glass element. Due to the fluid flow directed backward, it can also be prevented that the fluid emitted along the axial direction away from the specific end led to suction of air from the outside of the glass element.

The interplay between the different fluid releases can be described in the following way only by way of a preferred example: The forward air flow (especially released from a centrally located opening) creates an air cushion in the glass element so that the rearward/backward air flow does not create a vacuum in the glass tube, which might otherwise draw particles from the glass tube's end opposite the specific end (back) into the glass tube. Especially the backward-facing openings generate the cleaning airflow in the backward direction, i.e., in the backward direction of movement of the nozzle head. The particles may thus be driven backwards from approximately the center of the glass tube in front of the nozzle head and blown out of the specific end into which the nozzle was inserted.

In one embodiment it might be preferred that the method comprises applying a single mechanical shock impulse to the glass strand, especially via the glass strand support, during or immediately after separating the glass element from the glass strand. Preferably, the impulse can be applied to the glass strand via the roller.

This may further assist the process of separating the glass element from the glass strand.

Here, “immediately after separating the glass element from the glass strand” may for example mean within 2 seconds or less, preferably 1 second or less, preferably 0.5 seconds or less, preferably 0.3 seconds or less, preferably 0.1 seconds or less, preferably 0.05 seconds or less, preferably 0.03 seconds or less, preferably 0.01 seconds or less, preferably 0.001 seconds or less, and/or preferably at least 0.0001 seconds or more, after the glass element has been separated from the glass strand.

The problem is solved by the invention according to another aspect in that a method for separating a glass element from a glass strand is proposed. The method comprises separating, at a separating location of a production site, the glass element from the glass strand, and causing at least one specific portion of the glass strand to vibrate, especially (i) at least intermittently (i.e. from the to time) during separating the glass element from the glass strand, and/or (ii) throughout during separating the glass element from the glass strand.

All options which have been described above with respect to the method according to the first and/or second aspect of the invention may also be optional features of the method according to the present aspect of the invention. Therefore, all options may be realized also for the present method alone or in any combination.

Particularly it is preferred that the vibrations being transmitted to the glass strand by at least one glass strand support, such as at least one roller or at least one prism, which carries the glass strand at least in areas. For example, the roller, especially the one which is closest to the location where the glass element is separated from the glass strand, may comprise or may be made of carbon and/or coal. In one embodiment the roller comprises coal and carbon, wherein the two materials are layered together.

In one embodiment, causing the glass strand to vibrate alone, i.e. without performing the action of separating the glass element from the glass strand, is not causing the glass element being separated from the glass strand.

For the advantages of the present aspect of the invention, reference can be made to the explanations given above with respect to the first and/or second aspect of the invention, which apply mutatis mutandis also here.

In one embodiment it might be preferred that the method comprises applying a single mechanical shock impulse to the glass strand, especially via at least one glass strand support (such as the glass strand support which in addition may at least in part also causing the glass strand to vibrate), during or immediately after separating the glass element from the glass strand.

This may further assist the process of separating the glass element from the glass strand.

Here, “immediately after separating the glass element from the glass strand” may for example means within 2 seconds or less, preferably 1 second or less, preferably 0.5 seconds or less, preferably 0.3 seconds or less, preferably 0.1 seconds or less, preferably 0.05 seconds or less, preferably 0.03 seconds or less, preferably 0.01 seconds or less, preferably 0.001 seconds or less, and/or preferably at least 0.0001 seconds or more, after the glass element has been separated from the glass strand.

Again, the impulse may be applied alternatively or in addition to causing the glass strand to vibrate. If the impulse is applied in addition to causing the glass strand to vibrate, the impulse may be applied by the same glass strand support which also is at least in part responsible for causing the glass strand to vibrate.

The problem is solved by the invention according to a third aspect in that a glass element having a hollow body portion, wherein the hollow body portion comprises
i) a first end section comprising a first end of the glass element,
ii) a second end section comprising a second end of the glass element arranged opposite the first end, and
iii) a middle section arranged between the first end section and the second end section,
   each section having an inner surface,
   wherein there are at least two particles deposited on the inner surface of a specific end section which particles can be identified, wherein the specific end section is the first end section or the second end section,
   wherein each particle of the identified particles deposited on the inner surface of the specific end section can be or is classified for the purpose of a first classification by its size in one of a plurality of classes,
   wherein the plurality of classes comprises two or more first classes which together entirely cover a first range of particle size of between 40 μm inclusive and a defined or definable upper boundary value exclusive,
   wherein each particle of the identified particles having a size falling within the first range of particle size can be or is classified in the respective first class whose range of particle size covers the respective size of the respective particle,
   where the mean value of the particle size of the particles which can be or are classified in the plurality of first classes is smaller than the center value of the first range of particle size, is proposed.

The invention is, thus, based on the surprising finding that a glass element is particularly suited for holding sensitive substances such as pharmaceutical compositions if the surface enlargement of the glass element is limited. It turned out that a low surface enlargement prevents or at least reduces the diffusion of substances contained in the glass material to a composition hold by the glass element.

It has been astonishing that controlling the mean value of the particle size in the proposed manner allows to provide a high-quality glass element which is particularly suitable for holding pharmaceutical compositions. The inventive approach makes it quite easy to produce a respective glass element of high quality.

In particular, it is recognized that the proposed glass element with the considerably reduced number of especially larger particles can be produced at all for the first time by means of the proposed process according to the first, the another and/or the second aspect of the invention.

Each section of the first end section, the second end section and the middle section may have an inner and/or an outer surface. Each of all sections may be of equal length.

Preferably the at least two particles deposited on the inner surface of the specific end are comprised by the glass element. Thus, the glass element preferably comprises the two or more particles deposited on the inner surface of the specific end. In other words, the at least two particles can preferably be part or characteristic of the glass element.

It is preferred that one of the following approaches is applied for identifying of the respective particles deposited on the inner surface of the specific end section of the glass element which are to be classified:

The particles to be classified can be identified as follows: First, preferably after the outer surface of the glass element has been cleaned by means of a liquid solution, a support step is carried out by means of which an automated detection of possible particles is performed. For this purpose, the glass element is placed in a pipe inspection system of the company Compar (system characteristics: Version=1.0. 5; detection power=20 μm; measurement uncertainty=6 μm; resolution=2456×2058 pixels (5M pixels); camera=BASLER piA2400-17 gm; lens=Moritex MML03-HR110-5M; illumination=Metaphase MB-BL201_G-24 STROBE (exposure time: 80 μs); image processing software=Compar VisionExpert V3.2.0) and the automated detection for possible particles is performed across at least the specific end section. The automated detected possible particles are then inspected by means of a magnification unit, such as a microscope device “Wide Stand Microscope” from PEAK, by a human and identified as a particle on the inner surface of the specific end section in case it is an actual particle. The identified particles can then be classified as proposed. Preferably, the human inspects the specific end section of the glass element from outside of the glass element.

Alternatively, the particles to be classified may be identified as follows: By means of a magnification unit, such as a microscope device “Wide Stand Microscope” from PEAK, preferably after the outer surface of the glass element has been cleaned by means of a liquid solution, the specific end section of the glass element is inspected by a human for possible particles on the inner surface of the specific end section. All particles which are actual particles on the inner surface of the specific end section are identified as particles on the inner surface of the specific end section. The identified particles can then be classified as proposed. Preferably, the human inspects the specific end section of the glass element from outside of the glass element.

Alternatively, the particles to be classified may be identified as follows: In a dark room, the glass element to be examined is illuminated, e.g. with 5000 lux. The particles are identified by the diffraction, reflection or absorption of the light. A hand microscope, for example a hand microscope “Wide Stand Microscope” from PEAK, can be used to identify the particles. The particles optically identified in this way are visibly marked. The glass element marked in this way is viewed along the normal to the surface under a light microscope, for example the Axio Imager M2m from Zeiss, with lens LD EC Epiplan 50×/0.55 HD DIC and ocular PI 10×/2, to characterize and measure the length of the particles.

Preferably, the size (which is the classification feature) of the particles may relate to the largest extension visible in the viewing plane (Feret diameter). With this type of measurement, it is consciously accepted that the maximum longitudinal extent of a three-dimensional particle can also extent in the direction of the optical axis of a microscope, i.e. along the normal. In this case, a smaller value for the size of the particle is obtained than the actual value of the maximum longitudinal extent of the three-dimensional particle, for example a glass particle.

Optionally, particles having a size of less than 40 μm may not be considered as particles according to the invention described herein. Hence, it may not be necessary to identify such particles.

The person skilled in the art understands that especially only the identified particles which are deposited on the inner surface of the specific end section are made subject to the first classification.

The first range of particle size extends from a lower boundary value of 40 μm through an upper boundary value. While the lower boundary value is included in the first range of particle size, the upper boundary value is not included in the first range of particle size, hence, it is excluded. In other words, the first range of particle size is an interval which is left-closed and right-open.

The center value of the first range of particle size is or can be determined by the expression (lower boundary value+upper boundary value)/2=(40 μm+upper boundary value)/2.

For example, the upper boundary value may be defined as being 500 μm. For that upper boundary value the center value of the first range of particle size is (40 μm+500 μm)/2=(540 μm)/2=270 μm.

In one embodiment it might be preferred that the outer diameter of the glass element is between 6 mm and 60 mm, especially between 6 mm and 22 mm, between 8 mm and 22 mm, between 7 mm and 50 mm or between 9 mm and 25 mm.

In one embodiment it might be preferred that the inner diameter of the glass element is between 4 mm and 58 mm, especially between 4 mm and 19 mm, between 6 mm and 29 mm, between 5 mm and 47 mm or between 4 mm and 24 mm.

In one embodiment it might be preferred that the identification of the at least two particles is or can be carried out by means of a manual and/or automatic identification method; that each class of the plurality of classes covers a specific closed, open, left-closed and right-open, left-open and right-closed, left-open and right-unbounded, left-closed and right-unbounded, left-unbounded and right-open and/or left-unbounded and right-closed range of particle size; that all classes of the plurality of classes together cover the entire range of possible particle sizes; and/or that any two classes of the plurality of classes do not overlap.

Preferably, the identification is implemented according to one of the approaches outlined above.

In one embodiment it might be preferred that there are two or more first classes and/or each of the first classes has the same interval size;
that the plurality of classes comprises one or more second classes which together entirely cover a second range of particle size of less than 40 μm, wherein each particle of the identified particles having a size falling within the second range of particle size can be or is classified in the respective second class whose range of particle size covers the respective size of the respective particle;
and/or
that the plurality of classes comprises one or more third classes which together entirely cover a third range of particle size which is starting from and includes the upper boundary value, wherein each particle of the identified particles having a size falling within the third range of particle size can be or is classified in the respective third class whose range of particle size covers the respective size of the respective particle.

For example, the interval [0;1) and [1;2) has the same interval size. As commonly known, “[” means left-closed (i.e. including the lower boundary value) and “)” means right-open (i.e. excluding the upper boundary value).

For example, the interval (0;1] and (1;2] has the same interval size. As commonly known, “(” means left-open (i.e. excluding the lower boundary value) and “]” means right-closed (i.e. including the upper boundary value).

Preferably, there is only one third class, wherein the third class having an interval range starting from and including the upper boundary value and being right-unbounded (i.e. extending until positive infinity).

In one embodiment it might be preferred that the upper boundary value is 790 μm or less, preferably 590 μm or less, preferably 490 μm or less, preferably 390 μm or less, preferably 290 μm or less, preferably 190 μm or less, preferably 140 μm or less, preferably 90 μm or less, preferably 80 μm or less, preferably 60 μm or less, preferably 50 μm or less, and/or more than 40 μm, especially 50 μm or more, especially 90 μm or more.

Respective upper boundary values have been found to indicate a particular well-suited glass element for holding pharmaceutical compositions.

In one embodiment it might be preferred that for the number of particles M being classified in the respective first class which covers the lower end of the first range of particle size, and the number of particles N being classified in the respective first class which covers the upper end of the first range of particle size, the ratio N/M is smaller than 1, preferably smaller than 0.7, preferably smaller than 0.5, preferably smaller than 0.3.

In other words, there number of respective larger particles is smaller than the number of respective smaller particles. This is particular preferred for glass element for holding pharmaceutical compositions.

In one embodiment it might be preferred that the particles considered for classification are of spherical, fibrous and/or plate-like shape.

This is particularly preferred, as particles with such a shape may be specifically undesirable.

Preferably, the particles each has an extension in one or more, preferably in two or more, preferably in three, space directions.

In one embodiment it might be preferred that the plurality of classes comprises three or more, four or more or five or more first classes and/or the interval size of each first class is between 40 μm and 100 μm, preferably between 40 μm and 60 μm, preferably 50 μm;
that the plurality of classes comprises two or more second classes and/or each of the second classes has the same interval size;
and/or
that the plurality of classes comprises two or more third classes and/or each of the third classes has the same interval size.

Preferably, the interval size of each first class is identical. For example, each first class may have an interval size of 50 μm.

Preferably, the interval size of each second class is identical. For example, each second class may have an interval size of 10 μm.

In one embodiment it might be preferred that the first end section and/or the second end section has a length of 300 mm or less, preferably of 250 mm or less, preferably of 200 mm or less, preferably of 150 mm or less, preferably of 100 mm or less.

In one embodiment it might be preferred that for the length L of the specific end section, such as the first end section or the second end section, the inner radius R of the glass element, the number of particles O being classified in the first classes, the following relation holds:

$$O / ( 6 * R * L ) < 20 \; 000 / {m}^{2} .$$

A respective ratio concerning the number of particles and the inner surface area is particularly preferred as it turned out that such a glass element is particularly well-suited for holding pharmaceutical compositions.

In one embodiment it might be preferred that the glass element can be or has been cleaned and/or separated by a method according to the first, the another and/or the second aspect of the invention.

In one embodiment it might be preferred that the first classification is conducted after cleaning of the glass element and wherein a second classification, the process of which is identical to the process of the first classification, is conducted prior to cleaning of the glass element,
wherein preferably prior to cleaning of the glass element there are at least two particles deposited on the inner surface of the specific end section which particles can be identified,
wherein for the particle sizes of the particles which are classified in the first classes during the first classification a first mean value M1 and a first standard deviation S1 can be calculated,
wherein for the particle sizes of the particles which are classified in the first classes during the second classification a second mean value M2 and a second standard deviation S2 can be calculated,
wherein the ratio of the first standard deviation and the second standard deviation, S1/S2, is smaller than:

$$1 - \frac{M 2 - M 1}{M 2 + M 1} .$$

It turned out that cleaning a respective glass element by the described method allows to improve the capability of the glass element for being suitable for holding pharmaceutical compositions.

Since the process of the second classification is identical to the process of the first classification, all aspects concerning the classification as well as the identification of particles of the glass element described herein with respect to the first classification apply mutatis mutandis here, too. Thus, the aspects do not need to be repeated here.

In one embodiment it might be preferred that the first classification is conducted at the specific end section of the glass element, especially the specific end section being the first or second end section and/or after cleaning of the glass element, and wherein a third classification, the process of which is identical to the process of the first classification, is conducted, especially after cleaning of the glass element, at the other end section of the glass element, which other end section is different to the specific end section, especially the specific end section being the first end section and the other end section being the second end section or vice versa,
that preferably there are at least two particles deposited on the inner surface of the other end section which particles can be identified,
that the number of the particles which are classified in the plurality of first classes during the first classification is a first particle quantity,
that the number of particles which are classified in the plurality of first classes during the third classification is a second particle quantity,
that the first particle quantity is smaller than the second particle quantity and wherein the end section which is different to the specific end section comprises a venting hole, especially the ratio of the second particle quantity and the first particle quantity is larger than 1.1 and/or smaller than 10000.

Since the process of the third classification is identical to the process of the first classification, all aspects concerning the classification as well as the identification of particles of the glass element described herein with respect to the first classification apply mutatis mutandis here, too. So, they do not need to be repeated here.

Preferably the ratio of the second particle quantity and the first particle quantity is larger than 1.5, preferably larger than 1.8, preferably larger than 2, preferably larger than 5, preferably larger than 10, preferably larger than 15, preferably larger than 20, preferably larger than 25, preferably larger than 50, preferably larger than 100, preferably larger than 300, preferably larger than 500.

Preferably the ratio of the second particle quantity and the first particle quantity is smaller than 5000, preferably smaller than 3000, preferably smaller than 1000, preferably smaller than 500, preferably smaller than 300, preferably smaller than 100, preferably smaller than 50, preferably smaller than 30, preferably smaller than 20, preferably smaller than 15, preferably smaller than 10, preferably smaller than 5, preferably smaller than 2, preferably smaller than 1.8.

In one embodiment it might be preferred that the glass element is free of any particles on the inner surface at the first end section and/or the second end section having a particle size, preferably having a largest extension, of 1000 μm or more, preferably 900 μm or more, more preferably 800 μm or more, more preferably 700 μm or more, more preferably 600 μm or more, more preferably 500 μm or more, more preferably 400 μm or more, more preferably 300 μm or more, more preferably 200 μm or more, more preferably 100 μm or more, more preferably 50 μm or more.

In one embodiment it might be preferred that the particles under consideration are inorganic particles, glass particles and/or are selected from glass, metal, dust, salt, more preferably the particles are glass.

It is preferably understood by the person skilled in the art that particles of other materials than these stated can nevertheless be present on the inner and/or outer surface, however, these particles are not taken into consideration for classification. For example, if the particles were glass, then there can be no or very much salt particles present on the inner and/or outer surface. But they would not be relevant for the classification.

In one embodiment it might be preferred that the outer diameter of the hollow body portion is 3 mm or more, preferably 4 mm or more, more preferably 5 mm or more, more preferably 6 mm or more, more preferably 7 mm or more, more preferably 8 mm or more, more preferably 9 mm or more, more preferably 10 mm or more, more preferably 15 mm or more, more preferably 20 mm or more, and/or 20 cm or less, preferably 15 cm or less, more preferably 10 cm or less, more preferably 5 cm or less, more preferably 4 cm or less, more preferably 3 cm or less, more preferably 2 cm or less.

A glass element having a respective diameter allows to be manufactured in an easy manner.

In one embodiment it might be preferred that the inner diameter of the hollow body portion is 3 mm or more, preferably 4 mm or more, more preferably 5 mm or more, more preferably 6 mm or more, more preferably 7 mm or more, more preferably 8 mm or more, more preferably 9 mm or more, more preferably 10 mm or more, more preferably 15 mm or more, more preferably 20 mm or more, and/or 20 cm or less, preferably 15 cm or less, more preferably 10 cm or less, more preferably 5 cm or less, more preferably 4 cm or less, more preferably 3 cm or less, more preferably 2 cm or less.

A glass element having a respective diameter allows to be manufactured in an easy manner.

In one embodiment it might be preferred that the length of the hollow body portion is 0.5 m or more, preferably 1 m or more, preferably 1.3 m or more, preferably 1.5 m or more, and/or 2 m or less, preferably 1.7 m or less, preferably 1.5 m or less, preferably 1.3 m or less, preferably 1 m or less.

In one embodiment it might be preferred that the hollow body portion is at least in part designed as hollow cylindrical portion; the glass element is a glass tube; and/or the glass element comprises, preferably is made of, a borosilicate glass, a soda lime glass or aluminosilicate glass.

If the glass element is of a respective glass material, it ca be used in a plurality of scenarios.

A glass tube of high quality is of particularly interest.

In one embodiment it might be preferred that the first end of the glass element is an open end, especially the lumen of the glass element being in fluidal communication with the environment of the glass element via the first end of the glass element, and/or the second end of the glass element is an open end, especially the lumen of the glass element being in fluidal communication with the environment of the glass element via the second end of the glass element.

A glass element having one or more open ends allows to access the lumen easily.

In one embodiment it might be preferred that the first end of the glass element is a closed end and/or the second end of the glass element is a closed end.

A glass element having one or more closed end allows to reduce or even prevent further contaminations and is, therefore, preferred.

In one embodiment it might be preferred that the glass element is or can be produced by means of a Danner and/or a Vello process.

This allows for a cheap and efficient manufacturing process.

In one embodiment it might be preferred that the glass element has been cut to length from a longer, especially continuous, glass tube strand, preferably by scratching and/or breaking.

It is cheap and easy to produce a glass tube strand and confectioning this into smaller pieces in order to obtain a glass element of appropriate length.

In one embodiment it might be preferred that the glass element has been cleaned by means of at least one air stream applied at least in part to its inner and/or outer surface such that at least some of the particles deposited on the respective surface(s) are blown away from the surface and/or out of the lumen, and/or the air stream is moved relative to the glass element from the middle section to the first or second end of the glass element.

A glass element is of particularly high quality if it has been cleaned appropriately.

In one embodiment it might be preferred that the glass element has been set into vibration during the cleaning process, especially with a frequency of 100 to 50000 Hz, preferably 200 to 25000 Hz, more preferably 250 to 10000 Hz and/or an amplitude of 0.05 mm to 5 mm, preferably 0.1 mm to 1 mm, more preferably 0.5 mm to 0.7 mm.

Mechanical vibrating of the glass element allows to produce a glass element which is particularly free of particles which otherwise might detach on their own from the surface such as the inner or outer surface of the glass element at some later time. Thus, safety is improved.

In one embodiment it might be preferred that the glass element is cleaned before it is reheated and/or after it has been cut from a longer, especially continuous, glass tube strand, preferably by scratching and/or breaking.

This allows to ensure that loose particles are removed so that they are not heated and subsequently attach permanently at the surface. Hence, quality of the glass element is improved.

In one embodiment it might be preferred that the glass element does not contain any particles on the inner surface at the first and/or the second end section having a particle size, preferably having a largest extension, of 1000 μm or more, preferably 900 μm or more, more preferably 800 μm or more, more preferably 700 μm or more, more preferably 600 μm or more, more preferably 500 μm or more, more preferably 400 μm or more, more preferably 300 μm or more, more preferably 200 μm or more, more preferably 150 μm or more, more preferably 100 μm or more, more preferably 90 μm or more, more preferably 80 μm or more, more preferably 70 μm or more, more preferably 60 μm or more, more preferably 50 μm or more.

In one embodiment it might be preferred that the length of the hollow body portion is 2 cm or more, preferably 10 cm or more, more preferably 20 cm or more, more preferably 30 cm or more, more preferably 40 cm or more, more preferably 50 cm or more, more preferably 110 cm or more, and/or 500 cm or less, preferably 400 cm or less, more preferably 300 cm or less, more preferably 200 cm or less, more preferably 100 cm or less, more preferably 50 cm or less. In particular, the length of the hollow body portion can be 150 cm.

A glass element of respective length allows to easily produce a surface with improved quality.

In one embodiment it might be preferred that the number of particles on the inner surface at the middle section is 0 or more, preferably 50 or more, more preferably 100 or more, and/or 1000 or less, preferably 900 or less, more preferably 800 or less, more preferably 700 or less, more preferably 600 or less, more preferably 500 or less, more preferably 400 or less, more preferably 300 or less, more preferably 200 or less.

In one embodiment it might be preferred that the number of particles on the inner surface at the first and/or the second end section per cm² is in average 10 or less, preferably 9 or less, more preferably 8 or less, more preferably 7 or less, more preferably 6 or less, more preferably 5 or less, more preferably 4 or less, more preferably 3 or less, more preferably 2 or less, more preferably 1 or less, and/or the number of particles on the outer surface at the first and/or the second end section per mm2 is 10 or less, preferably 9 or less, more preferably 8 or less, more preferably 7 or less, more preferably 6 or less, more preferably 5 or less, more preferably 4 or less, more preferably 3 or less, more preferably 2 or less, more preferably 1 or less.

A glass element, such as the glass element of the third aspect of the invention or any embodiments described herein, which has been cleaned by means of and/or is obtainable by a method according to the first, the another and/or the second aspect of the invention is also proposed.

The problem is solved by the invention according to a fourth aspect in that a method according to the first aspect of the invention, wherein the glass element which is cleaned and/or separated during the method is a glass element according to the third aspect of the invention and wherein preferably the first classification is conducted after cleaning of the glass element by the method and/or the second classification is conducted prior to cleaning of the glass element by the method, is proposed.

The problem is solved by the invention according to a fifth aspect in that a bundle of glass elements, comprising a plurality, preferably between 2 and 5000, preferably 10 to 1000, more preferably 25 to 500, more preferably 50 to 300, more preferably 75 to 250, of glass elements according to the third aspect of the invention, is proposed.

Having a bundle of high quality glass elements allow to ensure quality over a large number of different glass elements which otherwise is not possible.

Herein, a bundle may be a trading, loading or packaging unit for distribution of glass elements, preferably empty pharmaceutical cylindrical containers, i.e. pharmaceutical cylindrical containers filled with a gas, e.g. air. For example, products usually, but not necessarily, of the same kind are combined as bundles when ordered together in retail or bundled in logistics. According to the invention, glass elements in the bundle can be separated by a spacer, for example a plastic or paper sheet, so that they are not in direct contact with each other during transport. Usually, but not necessarily, the bundle is at least partly covered by a plastic foil. Preferably, one bundle contains 5 to 5000, preferably 10 to 1000, more preferably 25 to 500, more preferably 50 to 300, most preferably 75 to 250 glass elements. An example of a bundle is the DENSOPACK® from SCHOTT AG. Due to economic reasons, preferably the bundle contains 25 to 500, more preferably 50 to 300, most preferably 75 to 250 glass elements, which are at least partly covered by a plastic foil and wherein the glass elements are in direct contact to each other within the bundle. Preferably, the length of the hollow body portion, preferably the hollow cylindrical portion of the glass elements in the bundle is 2 cm or more, preferably 10 cm or more, more preferably 20 cm or more, more preferably 30 cm or more, more preferably 40 cm or more, more preferably 50 cm or more, more preferably 100 cm or more, and/or 500 cm or less, preferably 400 cm or less, more preferably 300 cm or less, more preferably 200 cm or less, more preferably 100 cm or less, more preferably 50 cm or less.

In one embodiment it might be preferred that the bundle is at least in part packed in a foil.

A foil prevents the glass elements from further contaminations.

In one embodiment it might be preferred that at least some, preferably all, of the plurality of glass elements are kept within the bundle at a distance from each other by means of at least one, preferably a plurality of, spacing element(s).

A spacing elements prevents the glass elements from damages. This makes it possible to handle the bundle in a safe manner.

In one embodiment it might be preferred that at least some, preferably all, of the plurality of glass elements are in direct contact to each other.

A direct contact allows to reduce vibrations of the glass elements so that the bundle can be handled more secure.

In one embodiment it might be preferred that the mean values of the particle size of the particles which are classified in the plurality of first classes for the purpose of the first classification of each of the glass elements of the bundle have a standard deviation of less than 50 μm, preferably of less than 30 μm, preferably of less than 10 μm, preferably of less than 5 μm.

The problem is solved by the invention according to a sixth aspect in that a glass element having a hollow body portion, wherein the hollow body portion comprises
i) a first end section comprising a first end of the glass element,
ii) a second end section comprising a second end of the glass element arranged opposite the first end, and
iii) a middle section arranged between the first end section and the second end section,
each section having an inner surface,
wherein there are at least two particles deposited on the inner surface of a specific end section which particles can be identified, wherein the specific end section is the first end section or the second end section,
wherein each particle of the identified particles deposited on the inner surface of the specific end section can be or is classified for the purpose of a classification by its size in one of a plurality of classes,
wherein the plurality of classes comprises two or more first classes which together entirely cover a first range of particle size of between 40 μm inclusive and the upper boundary value exclusive,
wherein each particle of the identified particles having a size falling within the first range of particle size can be or is classified in the respective first class whose range of particle size covers the respective size of the respective particle,
where the mean value of the particle size of the particles which can be or are classified in the plurality of first classes is larger than the center value of the first range of particle size, is proposed.

All advantages and features disclosed above with respect to the third aspect of the invention apply mutatis mutandis alone and in every combination also here. Therefore, they need not be repeated here, but reference can be made to the explanations given above. Preferably, the classification is carried out prior to cleaning of the glass element.

### BRIEF DESCRIPTION OF THE DRAWINGS

Various aspects of this invention will become apparent to those skilled in the art from the following detailed description of preferred embodiments, when read in light of the accompanying schematic drawings, wherein

FIG. 1 shows a schematic diagram of a method according to the first aspect of the invention;

FIG. 2a shows a schematic illustration of a separating location of a production site;

FIG. 2b shows a glass strand support in a first state;

FIG. 2c shows a glass strand support in a second state; and

FIG. 2d shows schematic illustrations of a glass element for different time steps during the method according to the first aspect of the invention.

### DETAILED DESCRIPTION OF THE INVENTION

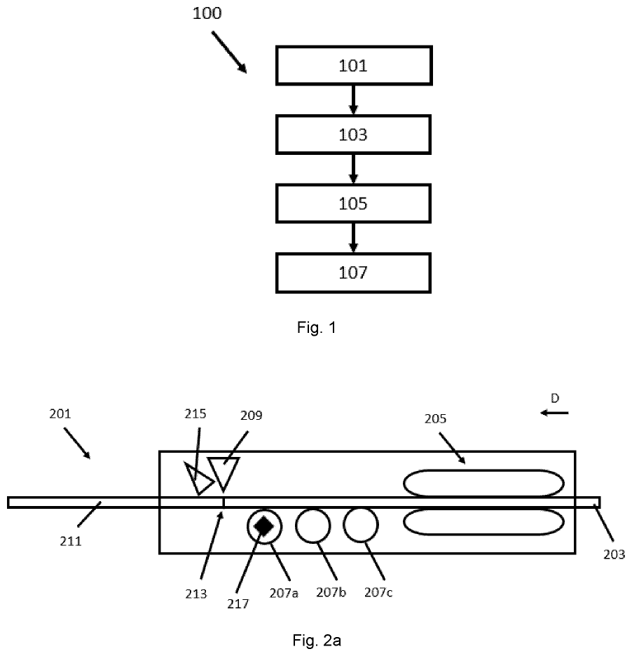

FIG. 1 shows a schematic diagram 100 of a method according to the first aspect of the invention concerning the cleaning of a glass element.

In 101 the glass element is separated from a glass strand at a separating location of a production site. During separating the glass element from the glass strand a suction of at least some of the particles that result from the separating is carried out.

Optionally, in 101, separating the glass element from the glass strand comprises: causing at least one specific portion of the glass strand, namely an end section of the glass strand, to vibrate.

In 103 the glass element is moved from the separating location to a cleaning location.

In 105 a nozzle head is inserted at a specific end of the glass element into the glass element and moved inside the glass element along a specific direction, which is parallel to the center axis of the glass element, while the nozzle head does not release fluid.

In 107 fluid is released out of the nozzle head (especially as a first fluid releasing action) so as to flush particles attached at the inner surface of the glass element towards the specific end while moving the nozzle head within the glass element along a direction which is opposite to the specific direction. Also in 107, fluid is preferably released out of the nozzle head (especially as a second fluid releasing action which is carried out in parallel to the first fluid releasing action) along at least one direction pointing away from the specific end and/or along at least one direction parallel to the specific direction.

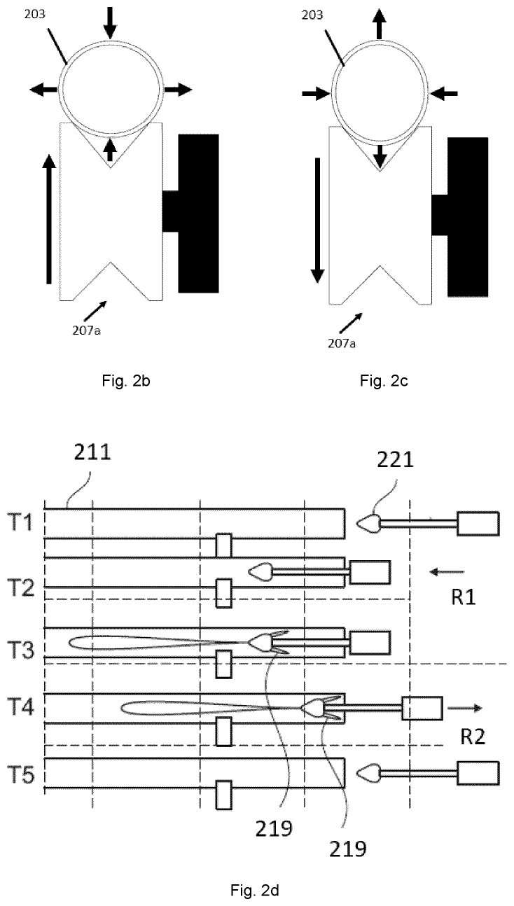

FIG. 2a shows a schematic illustration of a separating location 201 of a production site. 101 of the method described above might be carried out at separating location 201. But it is appreciated that the separating location 201 might be useful on its own as well, for example for the purpose of separating a glass element from a glass strand.

At the separation location 201, a glass strand 203 is provided which is pulled by a pulling device 205 along a direction D and which glass strand 203 is supported on glass strand supports 207a . . . c which are designed in the form of rollers. Furthermore, cutting means 209 are provided so that a glass element 211 can be separated from the glass strand 203 at a cutting position 213 (which cutting position 213 is indicated by a vertical line on the glass strand 203). There is also provided a device 215 configured to produce a vacuum for suction of at least some of the particles that result from the separation process.

Optionally, the support 207a may be designed so as to causing at least one specific portion of the glass strand, namely an end section of the glass strand, to vibrate. For this purpose, the glass strand support 207a comprises a vibration unit 217, for example in form of a piezo element.

FIGS. 2b and 2c illustrate the effect the vibration unit 217 has on the glass strand 203. FIG. 2b shows the support 207a while it moves upwards during vibrating (as indicated by the arrow). This causes the glass strand 203 which is supported by the support 207a to compress in the vertical direction and to expand in the horizontal direction (as indicated by the arrows).

FIG. 2c shows the support 207a while it moves downwards during vibrating (as indicated by the arrow). This causes the glass strand 203 to expand in the vertical direction and to compress in the horizontal direction (as indicated by the arrows).

The support 207a transmits vibrations on the glass strand so that the glass strand vibrates also in a region where cutting position 213 is located. This in turn improves the cutting edge of glass element 211 and in addition reduces the number of particles, especially on the inner surface of the glass element 211 originating from the separation process.

FIG. 2d shows a schematic illustration of a glass element, such as glass element 211, for different time steps T1 . . . T5 during cleaning, at a cleaning location of the site, the inside of the glass element with a fluid 219 which is released from a nozzle head 221. 105 and 107 of the method described above might be carried out as illustrated.

The nozzle head 221 is moved along a direction R1 inside the glass element 211 while the nozzle head 221 does not release fluid (see time steps T1 and T2) and the nozzle head 221 is moved in a direction R2 out of the glass element 211 while the nozzle head 221 releases fluid (see time steps T3, T4 and T5). I.e. during the period of time between T3 and T5 there may be carried out a first fluid releasing action. The direction R1 is parallel to the center axis of the glass element. The direction R2 is antiparallel to the direction R1.

While the first fluid releasing action is carried out at the same time also a second fluid releasing action is carried out in parallel. For this purpose, fluid is released out of the nozzle head 221 along at least one direction pointing in FIG. 2d to the left-hand side of the glass element 211. This is illustrated in FIG. 2d for time steps T3 and T4 by a fluid which is released to the left. The second fluid releasing action prevents a negative pressure being created within glass element 211.

The features disclosed in the description, the figures as well as the claims could be essential alone or in every combination for the realization of the invention in its different embodiments.

List of reference numerals

| | |
|---|---|
| 100 | Diagram |
| 101 | Separating a glass element from a glass strand |
| 103 | Moving the glass element from a separating location |
| | to a cleaning location |
| 105 | Inserting a nozzle head into the glass element and |
| | moving inside the glass element while the nozzle |
| | head does not release fluid |
| 107 | releasing fluid out of the nozzle head while moving |
| | the nozzle head within the glass element |
| 201 | Location |
| 203 | Glass strand |
| 205 | Pulling device |
| 207a . . . c | Glass strand supports |
| 209 | Cutting means |
| 211 | Glass element |
| 213 | Cutting position |
| 215 | Device |
| 217 | Vibrating unit |
| 219 | Fluid |
| 221 | Nozzle head |
| D, R1, R2 | Direction |
| T1, T2, T3, T4, T5 | Time step |

1.-19. (canceled)

20. A method for separating a glass element from a glass strand, the method comprising:
separating, at a separating location of a production site, the glass element from the glass strand, wherein separating the glass element from the glass strand comprises causing at least one specific portion of the glass strand to vibrate, wherein vibrations are transmitted to the glass strand by at least one glass strand support, in the form of at least one roller or at least one prism, which carries the glass strand at least in areas.

21. The method of claim 20, wherein the method comprises applying a single mechanical shock impulse to the glass strand via the at least one glass strand support during or immediately after separating the glass element from the glass strand.

22. A method for separating a glass element from a glass strand, the method comprising:
separating, at a separating location of a production site, the glass element from the glass strand; and
causing at least one specific portion of the glass strand to vibrate at least intermittently during separating the glass element from the glass strand and/or throughout during separating the glass element from the glass strand.

23. The method of claim 22, wherein the method comprises applying a single mechanical shock impulse to the glass strand via at least one glass strand support during or immediately after separating the glass element from the glass strand.

24. The method of claim 22, the method further comprising:
moving the glass element from the separating location to a cleaning location at the same or another production site;
inserting, at the cleaning location, a nozzle head at a specific end of the glass element into the glass element and moving the nozzle head inside the glass element along a specific direction while the nozzle head does not release fluid; and
releasing fluid out of the nozzle head so as to flush particles attached at an inner surface of the glass element towards the specific end as a first fluid releasing action within the glass element along a direction which is opposite to the specific direction; wherein at least during separating the glass element from the glass strand a suction of particles is carried out.

25. The method of claim 24, wherein the method comprises releasing fluid out of the nozzle head along at least one direction pointing away from the specific end and/or along at least one direction parallel to the specific direction as a second fluid releasing action; wherein: (i) the second fluid releasing action is carried out at least intermittently while the first fluid releasing action is carried out, (ii) the second fluid releasing action is not carried out while the first fluid releasing action is not carried out, (iii) the second fluid releasing action is carried out at the same time when the first fluid releasing action is carried out, and/or (iv) the fluid is released only while moving the nozzle head within the glass element along the direction which is opposite to the specific direction.

26. The method of claim 22, wherein at least during separating the glass element from the glass strand, the at least one specific portion of the glass strand is caused to vibrate.

27. A glass element, comprising:
a hollow body portion comprising:
a first end section comprising a first end of the glass element;
a second end section comprising a second end of the glass element arranged opposite the first end; and
a middle section arranged between the first end section and the second end section, each of the sections having an inner surface; wherein there are at least two particles deposited on the inner surface of a specific end section which particles can be identified, wherein the specific end section is the first end section or the second end section,
wherein each particle of the identified particles deposited on the inner surface of the specific end section can be or is classified for the purpose of a first classification by its size in one of a plurality of classes, wherein the plurality of classes comprises two or more first classes which together entirely cover a first range of particle size of between 40 μm inclusive and a defined or definable upper boundary value exclusive, wherein each particle of the identified particles having a size falling within the first range of particle size can be or is classified in the respective first class whose range of particle size covers the respective size of the respective particle, where a mean value of the particle size of the particles which can be or are classified in the plurality of first classes is smaller than a center value of the first range of particle size.

28. The glass element of claim 27, wherein:
there are two or more first classes and/or each of the first classes has the same interval size;
the plurality of classes comprises one or more second classes which together entirely cover a second range of particle size of less than 40 μm, wherein each particle of the identified particles having a size falling within the second range of particle size can be or is classified in the respective second class whose range of particle size covers the respective size of the respective particle; and/or
the plurality of classes comprises one or more third classes which together entirely cover a third range of particle size which is starting from and includes the upper boundary value, wherein each particle of the identified particles having a size falling within the third range of particle size can be or is classified in the respective third class whose range of particle size covers the respective size of the respective particle.

29. The glass element of claim 28, wherein the upper boundary value is 790 μm or less and/or more than 40 μm.

30. The glass element of claim 28, wherein:
the plurality of classes comprises three or more first classes and/or the interval size of each first class is between 40 μm and 100 μm;
the plurality of classes comprises two or more second classes and/or each of the second classes has the same interval size; and/or
the plurality of classes comprises two or more third classes and/or each of the third classes has the same interval size.

31. The glass element of claim 27, wherein the first end section and/or the second end section has a length of 300 mm or less; and/or the following relation holds: O/(6*R*L)<20000/m², wherein L is a length of the specific end section, R is an inner radius of the glass element, and O is the number of particles being classified in the first classes.

32. The glass element of claim 27, wherein the glass element is free of any particles on the inner surface at the first end section and/or the second end section having a particle size of 1000 μm or more.

33. The glass element of claim 27, wherein the identified particles are inorganic particles, glass particles and/or are selected from glass, metal, dust, and salt.

34. The glass element of claim 27, wherein an outer diameter of the hollow body portion is 3 mm or more and/or 20 cm or less.

35. The glass element of claim 27, wherein an inner diameter of the hollow body portion is 3 mm or more and/or 20 cm or less.

36. The glass element of claim 27, wherein a length of the hollow body portion is 0.5 m or more and/or 2 m or less.

37. The glass element of claim 27, wherein:
the hollow body portion is at least in part designed as hollow cylindrical portion;
the glass element is a glass tube;
the glass element comprises a borosilicate glass, a soda lime glass, or aluminosilicate glass;
the first end of the glass element is an open end and a lumen of the glass element is in fluidal communication with the environment of the glass element via the first end of the glass element, and/or the second end of the glass element is an open end and the lumen of the glass element is in fluidal communication with the environment of the glass element via the second end of the glass element;
the first end of the glass element is a closed end and/or the second end of the glass element is a closed end;
the glass element is or can be produced by a Danner process and/or a Vello process; and/or
the glass element has been cut to length from a longer glass tube strand.
